(19) United States
(12) Patent Application Publication
(10) Pub. No.: US 2025/0212281 A1
(43) Pub. Date: Jun. 26, 2025

(54) ELECTRONIC DEVICE AND CONTROL METHOD

(71) Applicant: SEIKO EPSON CORPORATION, Tokyo (JP)

(72) Inventor: Junpei KOIZUMI, Matsumoto-shi (JP)

(21) Appl. No.: 18/990,618

(22) Filed: Dec. 20, 2024

(30) Foreign Application Priority Data
Dec. 21, 2023 (JP) 2023-215684

(51) Int. Cl. H04W 76/18; H04W 76/15

(52) U.S. Cl. CPC H04W 76/18; H04W 76/15

(57) ABSTRACT

A first electronic device according to an aspect of the present disclosure includes: a first wireless communication unit configured to perform first wireless communication with a relay device by a first communication method; and a second wireless communication unit configured to perform second wireless communication with a second electronic device by a second communication method different from the first communication method. When an error occurs in the first wireless communication while the first wireless communication and the second wireless communication are being performed, the first electronic device transmits a first reconnection request by the first communication method to the relay device by the first wireless communication unit, and transmits a second reconnection request by the second communication method to the second electronic device by the second wireless communication unit.

The present application is based on, and claims priority from JP Application Serial Number 2023-215684, filed Dec. 21, 2023, the disclosure of which is hereby incorporated by reference herein in its entirety.

### BACKGROUND

### 1. Technical Field

The present disclosure relates to an electronic device and a control method.

### 2. Related Art

JP-A-2019-199004 discloses a technique for performing wireless communication by a wireless communication method that is given priority from a first wireless communication method and a second wireless communication method.

However, in the technique described in JP-A-2019-199004, wireless communication is performed using only one wireless communication method of the first wireless communication method and the second wireless communication method, and user convenience is reduced.

Therefore, it is desirable to develop a technique for performing wireless communication by both the first wireless communication method and the second wireless communication method without reducing user convenience.

### SUMMARY

An electronic device according to an aspect of the present disclosure includes: a first wireless communication unit configured to perform first wireless communication with a relay device by a first communication method; and a second wireless communication unit configured to perform second wireless communication with another electronic device by a second communication method different from the first communication method. When an error occurs in the first wireless communication while the first wireless communication and the second wireless communication are being performed, the first wireless communication unit transmits a first reconnection request by the first communication method to the relay device, and the second wireless communication unit transmits a second reconnection request by the second communication method to the other electronic device.

A control method according to an aspect of the present disclosure includes: by an electronic device including a first wireless communication unit configured to perform first wireless communication with a relay device by a first communication method, and a second wireless communication unit configured to perform second wireless communication with another electronic device by a second communication method different from the first communication method, when an error occurs in the first wireless communication while the first wireless communication and the second wireless communication are being performed, transmitting, by the first wireless communication unit, a first reconnection request by the first communication method to the relay device; and transmitting, by the second wireless communication unit, a second reconnection request by the second communication method to the other electronic device.

### BRIEF DESCRIPTION OF THE DRAWINGS

FIG. 1 is a block diagram showing a configuration example of a communication system including a first electronic device according to an embodiment.

FIG. 2 is a flow diagram showing a processing example of the first electronic device in the communication system in FIG. 1.

FIG. 3 is a block diagram showing a more specific configuration example of the communication system in FIG. 1.

FIG. 4 is a flow diagram showing a processing example in the communication system in FIG. 3.

FIG. 5 is a flow diagram showing a processing example in a communication system according to a comparative example.

FIG. 6 is a flow diagram showing another processing example of the electronic device in the communication system in FIG. 3.

FIG. 7 is a flow diagram showing another processing example in the communication system in FIG. 3.

FIG. 8 is a diagram showing an example of a hardware configuration of a device.

### DESCRIPTION OF EMBODIMENTS

Hereinafter, an embodiment of the present disclosure will be described with reference to the drawings. The drawings are merely an example showing the embodiment of the present disclosure. Not all of the components described in the embodiment of the present disclosure are essential components of the present disclosure.

### Embodiment

### System Configuration Example

A communication system including a first electronic device according to an

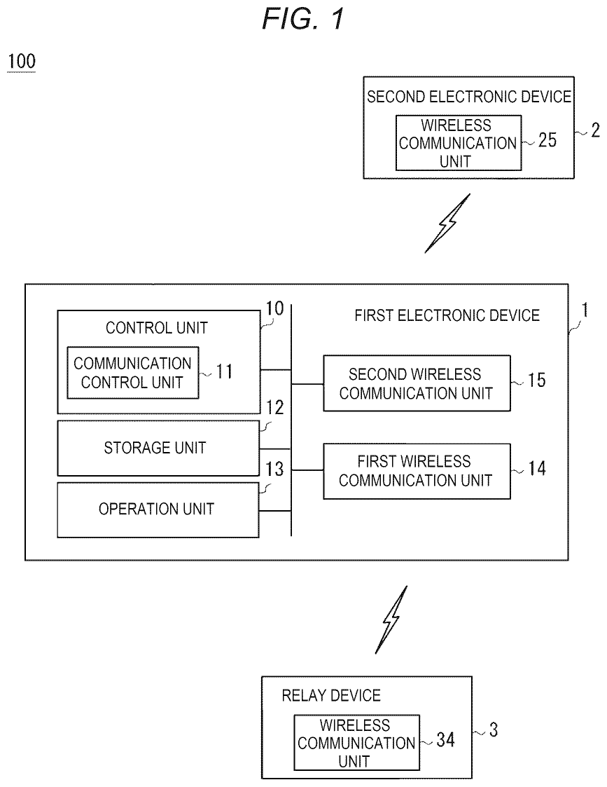

embodiment will be described with reference to FIG. 1. FIG. 1 is a block diagram showing a configuration example of such a communication system.

As shown in FIG. 1, a communication system 100 according to the embodiment may include a first electronic device 1, a second electronic device 2, and a relay device 3. Hereinafter, a schematic configuration example of the relay device 3, the second electronic device 2, and the first electronic device 1 will be described in this order.

### Schematic Configuration Example of Relay Device 3

The relay device 3 may be a device that relays signals for connecting the first electronic device 1 and a network (not shown). The relay device 3 may be, for example, a communication control device serving as an access point (AP) of the network or a communication control device having an AP function and a router function such as a wireless LAN router connected to the network. The LAN is an abbreviation for a local area network. The relay device 3 includes a wireless communication unit 34 that performs wireless communication with a first wireless communication unit 14 (to be described later) of the first electronic device 1. Other configurations of the relay device 3 will not be described.

### Schematic Configuration Example of Second Electronic Device 2

The second electronic device 2 may be a device having a communication function, such as a smartphone, a tablet terminal, a personal computer (PC), a printer, a handy terminal, an automatic change machine, or a credit card payment terminal. The handy terminal can be equipped with a scanning function for reading barcodes or the like. The second electronic device 2 is not limited to a portable type device, and may be an installation type device. The second electronic device 2 includes a wireless communication unit 25 that performs wireless communication with a second wireless communication unit 15 (to be described later) of the first electronic device 1. Other configurations of the second electronic device 2 will not be described.

### Schematic Configuration Example of First Electronic Device 1

The first electronic device 1 may be a concentrator having a function of communicating with a plurality of electronic devices. The concentrator may be simply referred to as a hub. Alternatively, the first electronic device 1 may be a device having a communication function such as a smartphone, a tablet terminal, or a PC. The first electronic device 1 is not limited to a portable type device, and may be an installation type device.

The first electronic device 1 may include a control unit 10 including a communication control unit 11, a storage unit 12, an operation unit 13, the first wireless communication unit 14, and the second wireless communication unit 15.

The control unit 10 can also be referred to as a controller, and controls the entire first electronic device 1. The control unit 10 may include the communication control unit 11 that controls communication in the first wireless communication unit 14 and the second wireless communication unit 15.

The control unit 10 may include an arithmetic processing device such as a central processing unit (CPU) or a graphics processing unit (GPU), a working memory, and a storage device that stores a control program, parameters, and so on. The control unit 10 or the communication control unit 11 may also be implemented as a system on a chip (SoC). The control unit 10 may be provided with a configuration in which the control program is stored in an executable state. The control unit 10 may have a configuration in which the control program is stored as a circuit configuration such as a field-programmable gate array (FPGA), or may be implemented as a dedicated circuit. The program may include a program for implementing functions of the first electronic device 1 in cooperation with the storage unit 12, the operation unit 13, the first wireless communication unit 14, and the second wireless communication unit 15.

The storage unit 12 is, for example, a hard disk drive, a solid state drive, or any other type of memory. A part of the memory provided to the control unit 10 may be regarded as the storage unit 12. That is, the storage unit 12 may also be regarded as a part of the control unit 10.

Although not shown, the first electronic device 1 may include a display unit for displaying information. The display unit can display an operation image that is a user interface (UI) image as the information. This operation image can be stored in the storage unit 12. The display unit is formed of, for example, a display device such as a liquid crystal display or an organic EL display. The display unit may have a configuration including a display and a drive circuit for driving the display.

The operation unit 13 is a region that receives an operation or an input by a user, and may also be referred to as an operation reception unit. The operation unit 13 may include, for example, a physical button group. The operation unit 13 may include a touch panel or a touch sensor mounted on a display unit (not shown). In this case, by the user performing a touch operation on the operation image displayed on the display unit, the operation unit 13 can receive an operation corresponding to an area where the touch operation is performed. The display unit for displaying an operation image and the operation unit 13 including the touch panel or the touch sensor mounted on the display unit can constitute an operation panel of the first electronic device 1. Some buttons of the physical button group may be configured to be capable of receiving an operation on the operation image. Obviously, some or all of the buttons of the physical button group may be configured to receive operations independent of the operation image.

The first wireless communication unit 14 performs first wireless communication with the relay device 3 by a first communication method. The first wireless communication unit 14 may be a communication interface for the first electronic device 1 to wirelessly communicate with an external device in accordance with a communication protocol of the first communication method. In the communication system 100, the external device may be the relay device 3, but may also be another device.

The second wireless communication unit 15 performs second wireless communication with another electronic device by a second communication method different from the first communication method. Here, the other electronic device is described as the second electronic device 2. The second wireless communication unit 15 may be a communication interface for the first electronic device 1 to wirelessly communicate with an external device in accordance with a communication protocol of the second communication method. In the communication system 100, the external device may be the second electronic device 2, but may also be another device.

The first electronic device 1 can be used as a device that communicates with the relay device 3 more frequently than with the second electronic device 2. In this case, the first communication method may adopt a communication method having a communication speed faster than the second communication method. There may be no difference in the communication speed between the first communication method and the second communication method. The second communication method may be a communication method having a communication speed faster than the first communication method.

In the first electronic device 1, when an error occurs in the first wireless communication while the first wireless communication and the second wireless communication are being performed, the first wireless communication unit 14 transmits a first reconnection request to the relay device 3, and the second wireless communication unit 15 transmits a second reconnection request to the second electronic device 2. Here, the error in the first wireless communication refers to a state in which the first wireless communication cannot be performed normally, and may be referred to as a wireless connection error for the first wireless communication.

Here, the first reconnection request is a reconnection request according to the first communication method. The second reconnection request is a reconnection request according to the second communication method. Transmission of the second reconnection request may be performed after transmission of a first connection request, transmission of the first reconnection request may be performed after transmission of a second connection request, or transmission of the first connection request and transmission of the second reconnection request may be started at the same timing.

In the configuration example in FIG. 1, the communication control unit 11 executes the transmission of such a first reconnection request and the transmission of such a second reconnection request by controlling the first wireless communication unit 14 and the second wireless communication unit 15, respectively. That is, when an error occurs in the first wireless communication while the first wireless communication and second wireless communication are being performed, the communication control unit 11 controls the first wireless communication unit 14 to transmit the first reconnection request to the relay device 3 and controls the second wireless communication unit 15 to transmit the second reconnection request to the second electronic device 2.

### Processing Example of First Electronic Device 1

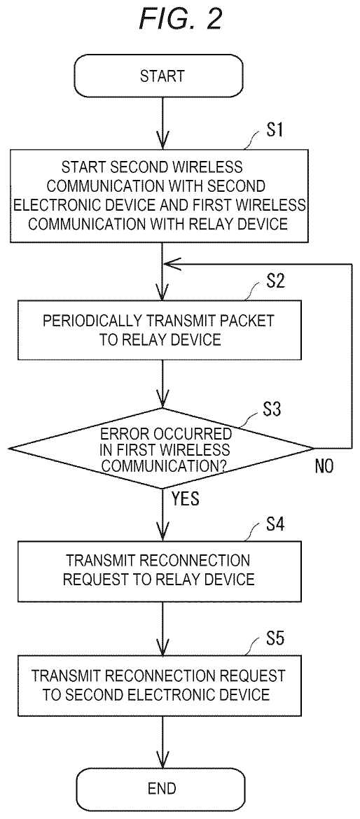

The processing example of the first electronic device 1 in the communication system 100 will be described with reference to FIG. 2. FIG. 2 is a flow diagram showing such a processing example.

The communication control unit 11 starts second wireless communication with the second electronic device 2, and starts first wireless communication with the relay device 3 (step S1). In step S1, an order of starting the first wireless communication and starting the second wireless communication does not matter.

Next, the communication control unit 11 controls the first wireless communication unit 14 to periodically transmit packets to the relay device 3 (step S2). Then, the communication control unit 11 determines whether an error occurs in the first wireless communication by determining whether there is a response from the relay device 3 with respect to the transmitted packet (step S3). Thus, the communication control unit 11 can determine whether an error occurs in the first wireless communication by periodically transmitting a packet to the relay device 3. The packets transmitted in step S2 may include packets transmitted for transmitting and receiving information between the first electronic device 1 and the relay device 3.

In a case of NO in step S3, the communication control unit 11 returns to step S2, waits for arrival of a periodic transmission timing, and controls the first wireless communication unit 14 to transmit a packet to the relay device 3.

In a case of YES in step S3, the communication control unit 11 controls the first wireless communication unit 14 to transmit a reconnection request to the relay device 3 (step S4). In step S4, when an error in the first wireless communication is resolved, the first wireless communication is resumed. After step S4, the communication control unit 11 controls the second wireless communication unit 15 to transmit a reconnection request to the second electronic device 2 (step S5), and ends the processing. In step S5, the second wireless communication is resumed. An order of steps S4 and S5 does not matter. Although the description is omitted, in steps S4 and S5, a partner to which a reconnection request is transmitted may be searched for in advance.

Step S3 will be additionally described. When an error occurs in the first wireless communication, an error occurs in the first wireless communication, and the first electronic device 1 or the control unit 10 or the communication control unit 11 may be restarted. When the control unit 10 is restarted or when the communication control unit 11 is restarted, the first wireless communication unit 14 and the second wireless communication unit 15 may be restarted simultaneously. A target for which restart is to be performed accompanying the occurrence of the error during the first wireless communication may be determined in advance, and may also be determined in advance according to a type of the error.

### More Specific Example of System Configuration (Configuration Example of Communication System 100a)

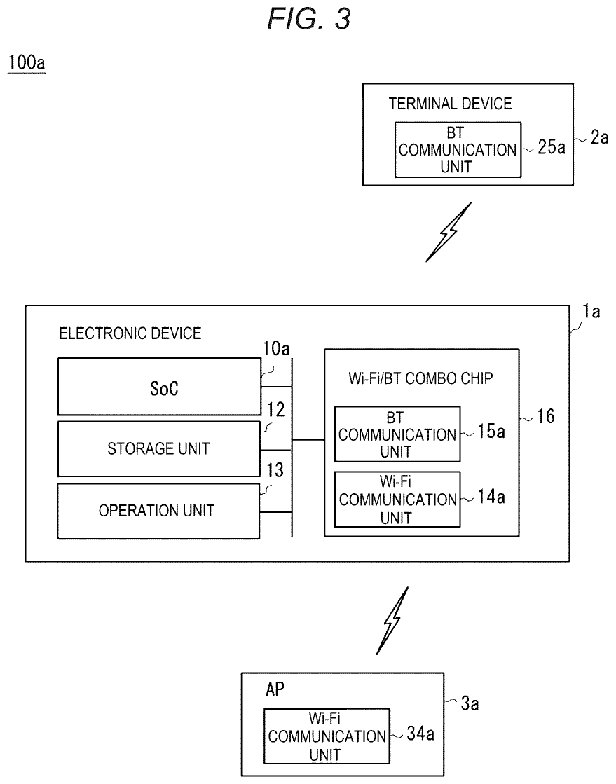

Next, a communication system 100a, which is a specific example of the communication system 100, will be described with reference to FIG. 3 by taking specific examples of the first communication method and the second communication method. FIG. 3 is a block diagram showing a more specific configuration example of the communication system 100.

The communication system 100a shown in FIG. 3 is an example of the communication system 100 shown in FIG. 1. An electronic device 1a is an example of the first electronic device 1, a terminal device 2a is an example of the second electronic device 2, and an AP 3a is an example of the relay device.

In the communication system 100a, an example is given in which the first communication method is a communication method conforming to the Wi-Fi (registered trademark; the same applies below) standard, and the second communication method is a communication method conforming to the Bluetooth (registered trademark; the same applies below) standard. Hereinafter, wireless communication according to a communication method conforming to the Wi-Fi standard is referred to as Wi-Fi communication, and wireless communication according to a communication method conforming to the Bluetooth standard is referred to as BT communication.

The Wi-Fi standard refers to, for example, a standard of IEEE (Institute of Electrical and Electronics Engineers) 802.11 and a derived standard thereof. Thus, a version of the Wi-Fi standard does not matter. A version of the Bluetooth standard does not matter. For example, the Bluetooth standard may be Bluetooth Low Energy.

The electronic device 1a includes an SoC 10a as an example of the control unit 10. The electronic device 1a includes a Wi-Fi communication unit 14a as an example of the first wireless communication unit 14. The Wi-Fi communication unit 14a is a wireless communication unit that performs Wi-Fi communication. The electronic device 1a includes a BT communication unit 15a as an example of the second wireless communication unit 15. The BT communication unit 15a is a wireless communication unit that performs BT communication. The electronic device1a includes the Wi-Fi communication unit 14a and the BT communication unit 15a as one IC chip. Hereinafter, the IC chip will be referred to as a Wi-Fi/BT combo chip 16 in the following description. In the Wi-Fi/BT combo chip 16, for example, an antenna used for Wi-Fi communication in the Wi-Fi communication unit 14a and an antenna used for BT communication in the BT communication unit 15a can also be configured to be shared.

The terminal device 2a includes a BT communication unit 25a as an example of the wireless communication unit 25. The BT communication unit 25a is a wireless communication unit that performs BT communication. The AP 3a includes a Wi-Fi communication unit 34a as an example of the wireless communication unit 34. The Wi-Fi communication unit 34a is a wireless communication unit that performs Wi-Fi communication.

The first communication method and the second communication method are not limited to the example described in FIG. 3. For example, the first communication method may be a communication method conforming to a communication standard such as a fourth generation mobile communication system or a fifth generation mobile communication system. For example, the second communication method may be a communication method conforming to other short-range wireless communication standard such as Zigbee (registered trademark).

### Processing Example of Communication System 100a

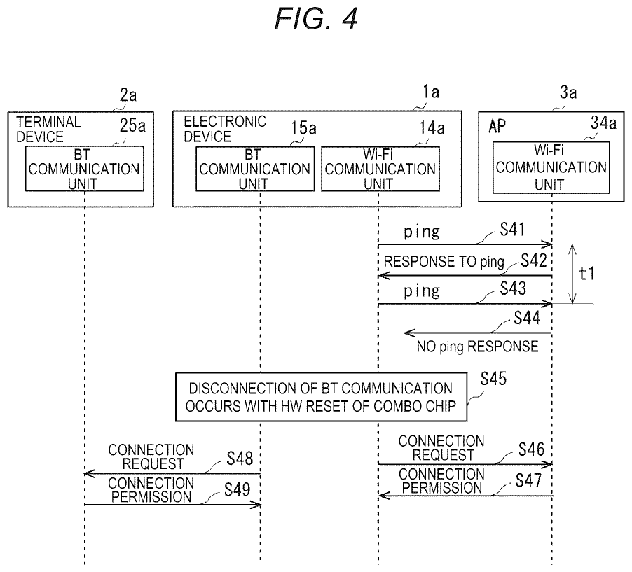

The processing example of the communication system 100a will be described with reference to FIG. 4. FIG. 4 is a flow diagram showing such a processing example. In FIG. 4, the processing example will be described from a state in which the electronic device 1a already performs BT communication with the terminal device 2a and Wi-Fi communication with the AP 3a.

The SoC 10a of the electronic device 1a transmits a ping to the AP 3a via the Wi-Fi communication unit 14a in order to determine whether there is an error in Wi-Fi communication (step S41). In response to the ping, the AP 3a returns a ping response (step S42). When the ping response is received, the SoC 10a of the electronic device la can determine that the Wi-Fi communication is being performed normally. The ping transmission in step S41 is periodically performed. For example, the SoC 10a of the electronic device 1a controls the Wi-Fi communication unit 14a to transmit a next ping to the AP 3a after t1 (s) in step S41 (step S43). A value of t1 does not matter, and may be set in advance to, for example, 10 ms.

Here, a case where there is no ping response to the ping transmission in step S43 will be described. When the ping response to the ping in step S43 cannot be received within a predetermined period from the AP 3a (step S44), the SoC 10a of the electronic device 1a restarts the Wi-Fi/BT combo chip 16, that is, performs hardware (HW) reset (step S45). The predetermined period may be predetermined as a period shorter than t1. In step S45, the HW reset also causes the BT communication to be disconnected.

After resetting the HW of the Wi-Fi/BT combo chip 16, the SoC 10a of the electronic device 1a transmits a connection request for Wi-Fi communication to the AP 3a (step S46). The AP 3a receives the connection request and transmits connection permission (step S47). Accordingly, connection for Wi-Fi communication between the electronic device 1a and the AP 3a is restored, and the Wi-Fi communication is resumed. Thus, in the electronic device 1a, the connection for Wi-Fi communication is disconnected after resetting the HW of the Wi-Fi/BT combo chip 16, but by automatically transmitting a connection request to the AP 3a, reconnection can be automatically performed.

After resetting the HW of the Wi-Fi/BT combo chip 16, the SoC 10a of the electronic device 1a transmits a connection request for BT communication, that is, a Bluetooth connection request to the terminal device 2a (step S48). The terminal device 2a receives the connection request and transmits connection permission (step S49). Accordingly, connection for the BT communication between the electronic device 1aand the terminal device 2a is performed again, and the BT communication is resumed. Thus, in the electronic device 1a, the Bluetooth connection is disconnected after resetting the HW of the Wi-Fi/BT combo chip 16, but by automatically transmitting a connection request to the terminal device 2a, reconnection can be automatically performed.

Therefore, in the electronic device 1a, a user does not need to issue a reconnection request for such BT communication from, for example, the operation unit 13, which reduces a workload of the user and enables the user to use both Wi-Fi communication and BT communication without stress. An example is described in which the processing of step S48 is executed after the processing of step S46. A processing order of steps S46 and S48 may be reversed or simultaneous.

### Description of Communication System According to Comparative Example

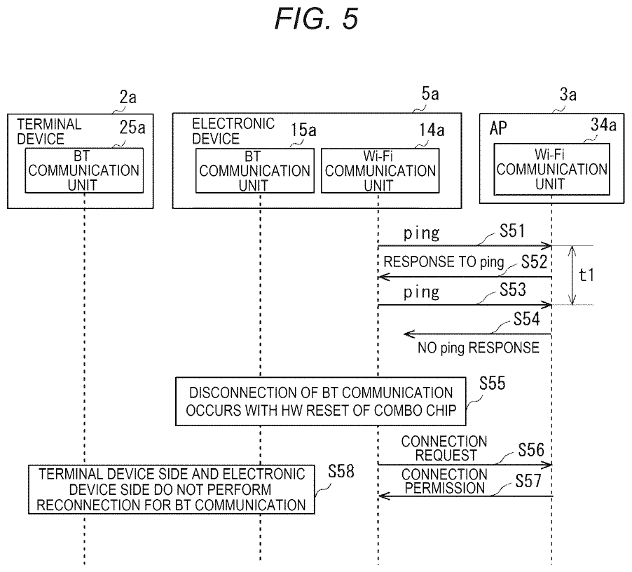

To describe an effect of the communication system 100, the communication system according to the comparative example will be described with reference to FIG. 5. FIG. 5 is a flow diagram showing a processing example in the communication system according to the comparative example.

The communication system according to the comparative example that executes the processing example shown in FIG. 5 includes an electronic device 5a, the terminal device 2a, and the AP 3a. The electronic device 5a is the electronic device 1a with different control over the BT communication unit 15a and the Wi-Fi communication unit 14a of the SoC 10a. In FIG. 5 as well, a processing example will be described from a state in which the electronic device 5a already performs BT communication with the terminal device 2a and Wi-Fi communication with the AP 3a.

A SoC (not shown) of the electronic device 5a transmits a ping to the AP 3a via the Wi-Fi communication unit 14a in order to determine whether there is an error in Wi-Fi communication (step S51), similar to step S41. In response to the ping, the AP 3a returns a ping response (step S52). When the ping response is received, the SoC of the electronic device 5a can determine that the Wi-Fi communication is being performed normally. The ping transmission in step S51 is periodically performed. For example, the SoC of the electronic device 5a controls the Wi-Fi communication unit 14a to transmit a next ping to the AP 3a after t1 (s) in step S51 (step S53).

Here, a case where there is no ping response to the ping transmission in step S53 will be described. When the ping response to the ping in step S53 cannot be received within a predetermined period from the AP 3a (step S54), the SoC of the electronic device 5a restarts the Wi-Fi/BT combo chip 16, that is, performs HW reset (step S55). In step S55, the HW reset also causes the BT communication to be disconnected.

After resetting the HW of the Wi-Fi/BT combo chip 16, the SOC of the electronic device 5a transmits a connection request for Wi-Fi communication to the AP 3a (step S56), similar to step S46. The AP 3a receives the connection request and transmits connection permission (step S57). Accordingly, connection for Wi-Fi communication between the electronic device 5a and the AP 3a is restored, and the Wi-Fi communication is resumed. Thus, even in the electronic device 5a, the connection for Wi-Fi communication is disconnected after resetting the HW of the Wi-Fi/BT combo chip 16, but by automatically transmitting a connection request to the AP 3a, reconnection can be automatically performed.

However, according to the Bluetooth standard, the SoC of the electronic device 5a does not perform reconnection to resume BT communication after resetting the HW of the Wi-Fi/BT combo chip 16, and the terminal device 2a also does not perform reconnection to resume BT communication (step S58). The reconnection for the BT communication is performed in response to a user operation from the terminal device 2a. Accordingly, in the communication system according to the comparative example, the connection for the BT communication between the electronic device 5a and the terminal device 2a remains unrestored, and BT communication is not resumed. Thus, in the communication system according to the comparative example, each time an error in Wi-Fi communication occurs, a user operation of reconnecting the necessary Bluetooth is required, which is stressful for the user.

### Effects of Embodiment

As described above, according to the communication system 100a, unlike the comparative example, each time an error in Wi-Fi communication occurs, the user is no longer required to reconnect the necessary Bluetooth, and can use the electronic device 1a without stress. Thus, in the embodiment, when wireless communication is performed using both the first communication method and the second communication method, an error may occur in wireless communication by one wireless communication method. Even in such a case, wireless communication between the two devices can be restored without any user operation. Therefore, according to the embodiment, wireless communication can be performed in both the first communication method and the second communication method without reducing user convenience.

### Another Processing Example 1 of Communication System 100a

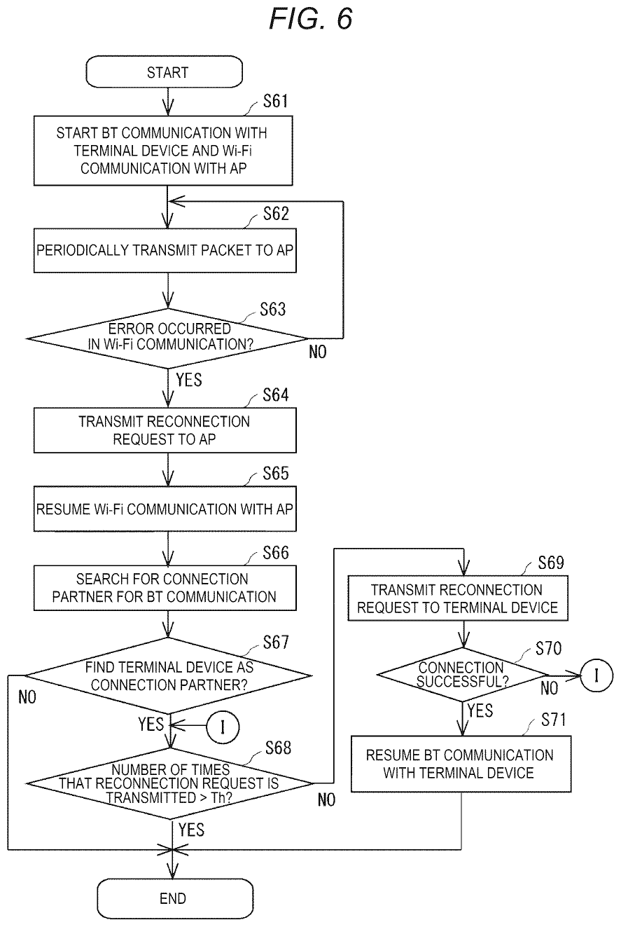

Another processing example of the electronic device 1a in the communication system 100a will be described with reference to FIG. 6. FIG. 6 is a flow diagram showing such a processing example.

The SoC 10a of the electronic device 1a starts BT communication with the terminal device 2a and starts Wi-Fi communication with the AP 3a (step S61). In step S61, an order of starting the Wi-Fi communication and starting the BT communication does not matter.

Next, the SoC 10a controls the Wi-Fi communication unit 14a to periodically transmit packets to the AP 3a (step S62). Then, the SoC 10a determines whether an error occurs in the Wi-Fi communication by determining whether there is a response from the AP 3a with respect to the transmitted packet (step S63). As in step S2 in FIG. 2, the packets transmitted in step S62 may include packets transmitted for transmitting and receiving information between the electronic device 1a and the AP 3a.

In a case of NO in step S63, the SoC 10a returns to step S62, waits for arrival of a periodic transmission timing, and controls the Wi-Fi communication unit 14a to transmit a packet to the AP 3a.

In a case of YES in step S63, the SoC 10a controls the Wi-Fi communication unit 14a to transmit a reconnection request to the AP 3a (step S64). In step S64, if an error in the Wi-Fi communication is resolved, the Wi-Fi communication is resumed (step S65).

Following step S64 or step S65, the SoC 10a controls the BT communication unit 15a to search for a connection partner for the BT communication (step S66). The SoC 10a determines whether the BT communication unit 15a finds the terminal device 2a as the connection partner (step S67), and in a case of NO, ends the processing. Thus, when the terminal device 2a that is a transmission destination of a reconnection request for the BT communication is not found, the SoC 10a may stop processing of transmitting the reconnection request. That is, when the terminal device 2a that is the transmission destination of the reconnection request for the BT communication is not found, the BT communication unit 15a may stop processing of transmitting the reconnection request.

In a case of YES in step S67, the SoC 10a determines whether the number of times that the reconnection request is transmitted exceeds a predetermined threshold value Th (step S68), and in a case of YES in step S68, ends the processing. A value of the predetermined threshold value Th does not matter, but may be determined in advance, for example, 10 times.

In a case of NO in step S68, the SoC 10a controls the BT communication unit 15a to transmit a reconnection request to the terminal device 2a (step S69). Next, the SoC 10a determines whether the connection is successful (step S70). In a case of YES in step S70, the SoC 10a resumes the BT communication with the terminal device 2a (step S71), and ends the processing. In a case of NO in step S70, the SoC 10a performs the processing of step S68.

Thus, when the SoC 10a cannot receive a connection response to the reconnection request for the BT communication from the terminal device 2a, the SoC 10a may transmit the reconnection request to the terminal device 2a again. When the number of times that the reconnection request is transmitted exceeds the predetermined threshold value, the SoC 10a may stop transmitting the reconnection request. That is, when the BT communication unit 15a cannot receive a connection response to the reconnection request for the BT communication from the terminal device 2a, the BT communication unit 15a may transmit the reconnection request to the terminal device 2a again, and may stop transmitting the reconnection request when the number of times of transmission exceeds the predetermined threshold value.

As described above, in the processing example 1, reconnection processing for the BT communication can be stopped under a specific condition, and continuation of transmission of the reconnection request even when BT communication is not possible can be prevented. Here, the specific condition includes the condition as illustrated in step S67 that a connection partner cannot be found and the condition that a reconnection request fails because the number of times of transmission exceeds a predetermined threshold value, but other conditions may also be used.

An order of step S64 and step S66 does not matter. For example, the processing of step S64 may be executed after the processing of step S66, the processing of step S64 and the processing of step S66 may be executed simultaneously, or the processing of steps S64 and S65 may be executed after the processing of steps S66 to S71.

### Another Processing Example 2 of Communication System 100a

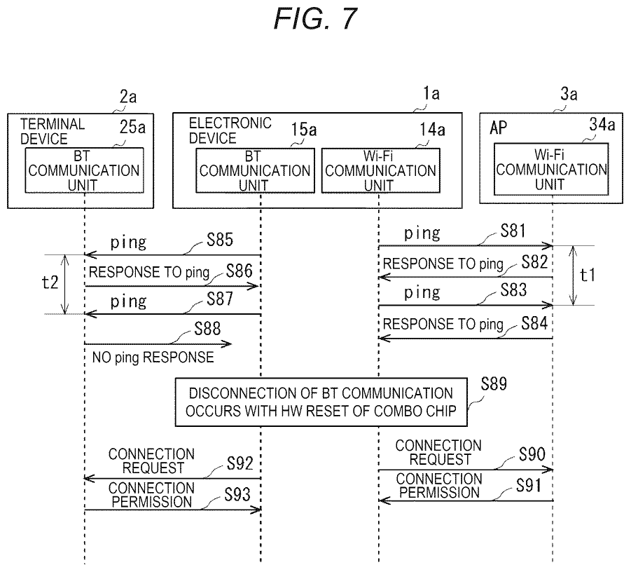

Another processing example of the communication system 100a will be described with reference to FIG. 7. FIG. 7 is a flow diagram showing such a processing example.

The processing example 2 is a processing example in a scene in which the terminal device 2a is connected to the AP 3a using Bluetooth tethering in the communication system 100a. That is, in the processing example 2, a case will be described in which the terminal device 2a is connected to a network connected by the Wi-Fi communication unit 14a via the BT communication unit 15a of the electronic device . In FIG. 7, a processing example will be described from a state in which the electronic device 1a already performs Wi-Fi communication with the AP 3a and Bluetooth tethering with the terminal device 2a by BT communication.

In such a connection environment, there is a protocol in the electronic device 1a that can perform a communication check regardless of a type of a partner device, such as a ping, which is a general communication check in TCP/IP communication. TCP/IP is an abbreviation for Transmission Control Protocol/Internet Protocol.

Therefore, the SoC 10a of the electronic device 1a can determine whether an error occurs in the Wi-Fi communication by periodically transmitting a packet to the terminal device 2a via the BT communication. In the processing example 2, for example, such determination can be performed in the following procedure.

As in the processing of steps S41 to 43 of FIG. 4, the SoC 10a of the electronic device 1a transmits and receives a ping to and from the AP 3a via the Wi-Fi communication unit 14a in order to determine whether there is an error in Wi-Fi communication (steps S81 to S83). Here, a case will be described in which the SoC 10a receives a ping response to the ping transmitted in step S83 via the Wi-Fi communication unit 14a (step S84).

In parallel with steps S81 to S84, the SoC 10a of the electronic device 1a transmits a ping to the terminal device 2a via the BT communication unit 15a in order to determine whether there is an error in BT communication (step S85). In response to the ping, the terminal device 2a returns a ping response (step S86). When the ping response is received, the SoC 10a of the electronic device 1a can determine that the BT communication is being performed normally. The ping transmission in step S85 is also periodically performed. For example, the SoC 10a of the electronic device 1a controls the BT communication unit 15a to transmit a next ping to the terminal device 2a after t2 (s) in step S85 (step S87). A value of t2 does not matter and may be the same as or different from t1. For example, t2 may be set in advance to, for example, 10 ms.

Here, a case where there is no ping response to the ping transmission in step S87 will be described. When the ping response to the ping in step S87 cannot be received within a predetermined period from the terminal device 2a (step S88), the SoC 10a of the electronic device 1a restarts the Wi-Fi/BT combo chip 16, that is, performs HW reset (step S89). The predetermined period may be predetermined as a period shorter than t2. In step S89, the HW reset also causes the BT communication to be disconnected.

As in steps S46 and S47, after resetting the HW of the Wi-Fi/BT combo chip 16, the SoC 10a of the electronic device 1a transmits a connection request for Wi-Fi communication to the AP 3a (step S90), and receives connection permission in response (Step S91). Accordingly, connection for Wi-Fi communication between the electronic device 1a and the AP 3a is restored, and the Wi-Fi communication is resumed. Thus, in the electronic device 1a, the connection for Wi-Fi communication is disconnected after resetting the HW of the Wi-Fi/BT combo chip 16, but by automatically transmitting a connection request to the AP 3a, reconnection can be automatically performed.

As in steps S48 and S49, after resetting the HW of the Wi-Fi/BT combo chip 16, the SoC 10a of the electronic device 1a transmits a connection request for BT communication to the terminal device 2a (step S92), and receives connection permission in response (Step S93). Accordingly, connection for BT communication between the electronic device 1a and the terminal device 2a is performed again, BT communication is resumed, and Bluetooth tethering is also resumed. Thus, in the electronic device 1a, the Bluetooth connection is disconnected after resetting the HW of the Wi-Fi/BT combo chip 16, but by automatically transmitting a connection request to the terminal device 2a, reconnection can be automatically performed.

Therefore, in the processing example 2 as well, in the electronic device 1a, a user does not need to issue a reconnection request for such BT communication from, for example, the operation unit 13, which reduces a workload of the user and enables the user to use both Wi-Fi communication and BT communication without stress.

The processing example 2 corresponds to the processing example 1 described with reference to FIG. 6, in which, together with the processing of step S62, packets are periodically transmitted to the terminal device 2a. In the processing example 2, it is also possible to determine whether an error occurs in the Wi-Fi communication based on whether an error occurs in the BT communication in step S63.

### Other Modifications

The present disclosure is not limited to the embodiment, and can be appropriately modified without departing from the scope of the present disclosure. For example, devices such as the first electronic device, the second electronic device, and the relay device applied to the communication system according to the embodiment are not limited to those illustrated.

In the embodiment, it is assumed that the communication control unit 11 controls both the first wireless communication unit 14 and the second wireless communication unit 15, such as the SoC 10a controlling both the Wi-Fi communication unit 14a and the BT communication unit 15a. In the embodiment, a first communication control unit that controls communication of the first wireless communication unit 14 and a second communication control unit that controls communication of the second wireless communication unit 15 may be separately provided. Even in such a configuration example, when an error occurs in communication in the first wireless communication unit 14, it can be said that there is a concern that an error may occur in communication in the second wireless communication unit 15. Similarly, it can be said to be beneficial to execute processing of transmitting a reconnection request for both wireless communications.

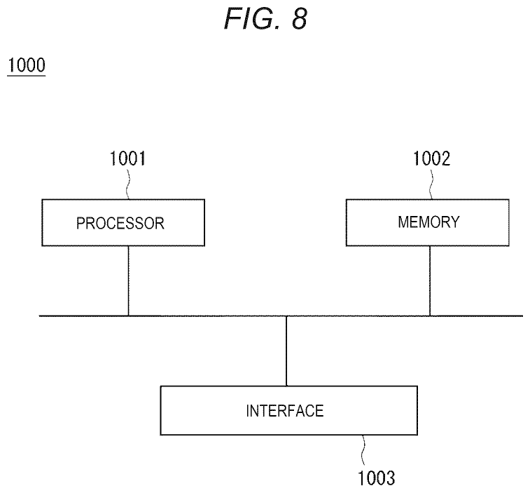

Devices such as the first electronic device, the second electronic device, and the relay device in the communication system according to the above-described embodiment may have the following hardware configuration, for example. FIG. 8 is a diagram showing an example of a hardware configuration of a device.

A device 1000 shown in FIG. 8 may include a processor 1001, a memory 1002, and an interface 1003. The interface 1003 may include, for example, a communication interface or an interface with a sensor and an input-output device, which are necessary depending on the device.

The processor 1001 may be, for example, a CPU, a graphics processing unit (GPU), or a micro processor unit (MPU) also referred to as a microprocessor. The processor 1001 may include a plurality of processors. The memory 1002 is implemented, for example, with a combination of a volatile memory and a nonvolatile memory. Functions of the devices are implemented by the processor 1001 reading a program stored in the memory 1002 and executing the program while exchanging necessary information via the interface 1003.

The program contains an instruction group (or software codes) that causes a computer to provide one or more of the functions described in the embodiment when the program is loaded into the computer. The program may be stored in a non-transitory computer-readable medium or a tangible storage medium. Examples of the computer-readable medium or the tangible storage medium include, but are not limited to, a random-access memory (RAM), a read-only memory (ROM), a flash memory, a solid-state drive (SSD), and other memory technologies. Examples of the computer-readable medium or the tangible storage medium include, but are not limited to, a CD-ROM, a digital versatile disc (DVD), a Blu-ray (registered trademark) disk, another optical disk storage, a magnetic cassette, a magnetic tape, a magnetic disk storage, or another magnetic storage device. The program may be transmitted via a transitory computer-readable medium or a communication medium. The transitory computer-readable medium or the communication medium may be, but not limited to, a signal that propagates electrically, optically, acoustically, or in other forms.

The present disclosure has been described with reference to the aforementioned embodiment. The present disclosure is not limited only to the configuration in the aforementioned embodiment, and it goes without saying that the present disclosure includes various variations, modifications, and combinations that can be achieved by those skilled in the art within the scope of the disclosure in the claims of the present application.

What is claimed is:

1. An electronic device comprising:
a first wireless communication unit configured to perform first wireless communication with a relay device by a first communication method; and
a second wireless communication unit configured to perform second wireless communication with another electronic device by a second communication method different from the first communication method, wherein
when an error occurs in the first wireless communication while the first wireless communication and the second wireless communication are being performed, the first wireless communication unit transmits a first reconnection request by the first communication method to the relay device, and the second wireless communication unit transmits a second reconnection request by the second communication method to the other electronic device.

2. The electronic device according to claim 1, further comprising:
a communication controller configured to control communication of the first wireless communication unit and the second wireless communication unit, wherein
when an error occurs in the first wireless communication while the first wireless communication and the second wireless communication are being performed, the communication controller controls the first wireless communication unit to transmit the first reconnection request to the relay device, and controls the second wireless communication unit to transmit the second reconnection request to the other electronic device.

3. The electronic device according to claim 1, wherein
whether the error occurs is determined by periodically transmitting a packet to the relay device.

4. The electronic device according to claim 1, wherein
when the other electronic device is connected to a network connected by the first wireless communication unit via the second wireless communication unit, whether the error occurs is determined by periodically transmitting a packet to the other electronic device via the second wireless communication.

5. The electronic device according to claim 1, wherein
the second wireless communication unit stops transmitting the second reconnection request when the other electronic device, which is a transmission destination of the second reconnection request, is not found.

6. The electronic device according to claim 1, wherein
the second wireless communication unit transmits the second reconnection request to the other electronic device again when a connection response to the second reconnection request is not received from the other electronic device, and stops transmitting the second reconnection request when the number of times that the second reconnection request is transmitted exceeds a predetermined threshold value.

7. The electronic device according to claim 1, wherein
the first communication method is a communication method conforming to a Wi-Fi standard, and
the second communication method is a communication method conforming to a Bluetooth standard.

8. A control method comprising:
by an electronic device including a first wireless communication unit configured to perform first wireless communication with a relay device by a first communication method, and a second wireless communication unit configured to perform second wireless communication with another electronic device by a second communication method different from the first communication method,
when an error occurs in the first wireless communication while the first wireless communication and the second wireless communication are being performed,
transmitting, by the first wireless communication unit, a first reconnection request by the first communication method to the relay device; and
transmitting, by the second wireless communication unit, a second reconnection request by the second communication method to the other electronic device.
